(19) United States
(12) Patent Application Publication
(10) Pub. No.: US 2026/0180856 A1
(43) Pub. Date: Jun. 25, 2026

(54) SYSTEM AND METHOD FOR ANALYZING TELECOMMUNICATIONS TRAFFIC INCREASE

(71) Applicant: T-MOBILE INNOVATIONS LLC, Overland Park, KS (US)

(72) Inventor: Yousef ALABSSI, Parsippany, NJ (US)

(21) Appl. No.: 18/991,300

(22) Filed: Dec. 20, 2024

(51) Int. Cl. H04L 41/0823; H04L 43/04; H04L 43/062

(52) U.S. Cl. CPC H04L 41/0823; H04L 43/04; H04L 43/062

(57) ABSTRACT

Systems and methods are provided for optimizing network performance through the analysis of application-specific traffic patterns in a telecommunications network. By processing traffic-related metadata, anomalies in application-specific traffic behavior are detected and analyzed. The system generates insights that identify the origin and impact of traffic fluctuations, enabling dynamic adjustments to network configurations. These adjustments ensure efficient resource allocation, improve Quality of Service (QoS), and enhance overall network reliability.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for deriving insights into application-specific traffic patterns and network resource utilization in telecommunications networks. Such insights are critical for addressing sudden traffic surges caused by popular applications or events (e.g., Netflix™ streaming, online gaming tournaments, NFL® games). Current challenges arise from the lack of precise tools to identify the root causes of these telecommunication traffic increases, leading to inefficient network resource allocation and potential service degradation. Without a comprehensive framework for analyzing traffic spikes and correlating them with specific applications, operators face difficulties in maintaining Quality of Service (QoS) and meeting user expectations, which can negatively impact the overall subscriber experience.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2A depicts a data processing graph in which implementations of the present disclosure may be employed, in accordance with aspects herein;

FIG. 2B depicts a data processing graph in which implementations of the present disclosure may be employed, in accordance with aspects herein;

FIG. 3 depicts a flow diagram of a method for identifying application-specific traffic patterns at a telecommunications network, in accordance with aspects herein;

FIG. 4 depicts a flow diagram of a method for dynamically allocating network resources at a telecommunications network, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 52d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As employed herein, a UE (also referenced herein as a user device) can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

By way of background, radio frequency (RF) engineers often encounter unanticipated increases in network traffic that are difficult to diagnose efficiently. Such traffic surges may result from various causes, including streaming services (e.g., Netflix™), large-scale gaming events (e.g., Xbox® tournaments), or widely viewed sporting events (e.g., NFL® games). These traffic spikes impose significant strain on network capacity, often resulting in degraded performance and customer dissatisfaction. Existing diagnostic tools lack the capability to pinpoint the specific applications responsible for the traffic increases, requiring RF engineers to engage in time-consuming and manual troubleshooting efforts. This approach delays resolution and inhibits effective resource planning, leaving the network vulnerable to recurring congestion during periods of heightened demand.

Conventional methods for addressing traffic surges involve the use of basic Deep Packet Inspection (DPI) at the User Plane Function (UPF) and the manual analysis of Event Data Records (EDRs). DPI inspects packet headers and payloads to classify traffic into general categories such as video streaming, gaming, or messaging. However, encryption and rapidly evolving traffic patterns often hinder the ability to identify specific applications with precision. EDRs are typically collected on a daily or weekly basis and processed manually to identify general traffic patterns. While these methods enable RF engineers to correlate traffic surges with general and broad categories of network usage, they fail to provide application-specific insights or support proactive capacity planning.

The present disclosure is directed to systems and methods for identifying and analyzing application-specific traffic patterns within telecommunications networks. The disclosed system utilizes advanced DPI techniques and machine learning (ML) algorithms to extract and process EDR logs. In aspects, DPI at the UPF generates enriched metadata, including traffic burst patterns and application signatures, enabling the identification of specific applications such as Netflix™ or Xbox® gaming services. The EDR logs are processed using ML algorithms, such as Local Outlier Factor (LOF), which perform clustering and anomaly detection to identify traffic outliers and correlate them with specific applications. The system provides RF engineers with granular and actionable insights into traffic patterns, significantly reducing the time required for troubleshooting. In embodiments, the system may operate on a feedback loop, enabling retrospective analysis of traffic surges. In alternative embodiments, the system may operate in real-time using ML, allowing proactive capacity planning and dynamic resource management. For example, the system could predict traffic spikes associated with major events and implement network configurations, such as traffic freezes or capacity scaling, in anticipation of demand.

Accordingly, a first aspect of the present disclosure is directed to a method for identifying application-specific traffic patterns in a telecommunications network. The method comprises generating traffic-related metadata using an event data record (EDR) log, wherein the EDR log comprises application-specific traffic information. The method also comprises clustering the EDR logs to determine outliers in the traffic-related metadata, and generating a report that identifies each outlier in the traffic-related metadata. Based on each outlier, the method also comprises adjusting application-level network configurations.

A second aspect of the present disclosure is directed to a system for identifying application-specific traffic patterns in a telecommunications network, the system comprising one or more processors and one or more computer-readable media storing computer-usable instructions that, when executed by the one or more processors, cause the one or more processors to generate traffic-related metadata using an event data record (EDR) log, wherein the EDR log comprises application-specific traffic information. The system also comprises clustering the EDR logs to determine outliers in the traffic-related metadata, and generating a report that identifies each outlier in the traffic-related metadata. Based on each outlier, the system also comprises adjusting application-level network configurations.

Another aspect of the present disclosure is directed to a method for dynamically allocating network resources in a telecommunications network based on application-specific traffic patterns. The method comprises generating traffic-related metadata using event data record (EDR) logs, wherein the EDR logs comprise application-specific traffic information for a plurality of applications. The method also comprises clustering the EDR logs to determine outliers in the traffic-related metadata, identifying that a traffic volume associated with a first application exceeds a predetermined threshold, and identifying a traffic volume associated with a second application remains within the predetermined threshold. The method also comprises generating a report that identifies the first application as an outlier, and based on the outlier status if the first application, the method comprises allocating additional network resources to the first application.

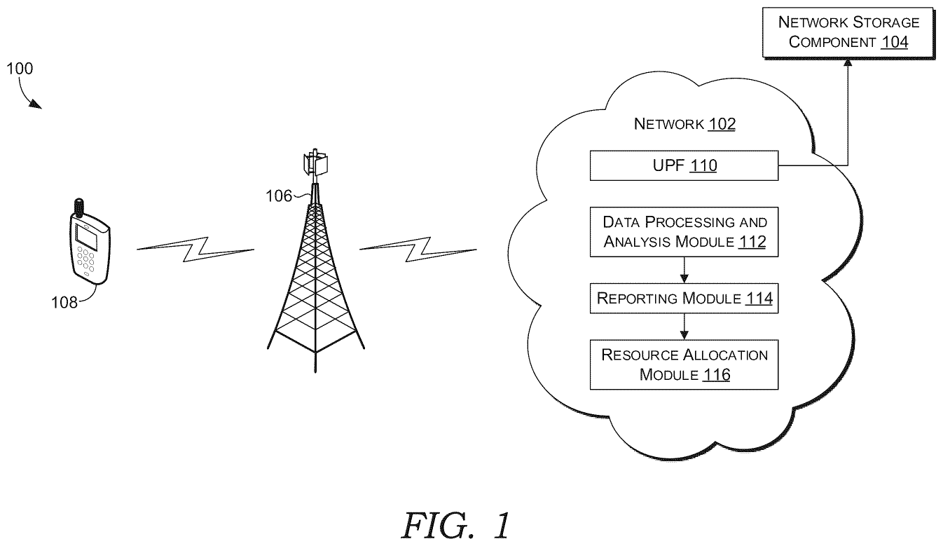

Turning to FIG. 1, a network environment designated generally as network environment 100 suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Further, neither should the network environment 100 be interpreted as having any dependency or requirement relating to any one or combination of components illustrated.

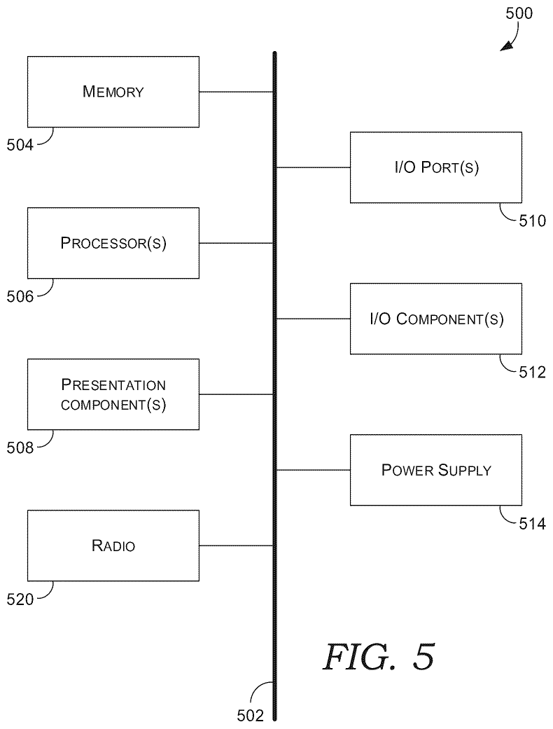

A network cell may comprise a base station (e.g., base station 106) to facilitate wireless communication between a communications device within the network cell, such as a UE communications device (e.g., UE 108) described with respect to FIG. 5, and a network. As shown in FIG. 1, the UE 108 may communicate with other devices, such as mobile devices, servers, etc. The UE 108 may take on a variety of forms, such as a personal computer, a laptop computer, a tablet, a netbook, a mobile phone, a smartphone, a personal digital assistant, or any other device capable of communicating with other devices. For example, the UE 108 may take on any form such as, for example, a mobile device or any other computing device capable of wirelessly communicating with the other devices using a network. In embodiments, UE 108 comprises a mobile or wireless device with which a wireless telecommunication network(s) can be utilized for communication (e.g., voice and/or data communication). In this regard, the UE 108 can be any mobile computing device that communicates by way of, for example, a 5G network.

The UE 108 may utilize network 102 to communicate with other computing devices (e.g., mobile device(s), a server(s), a personal computer(s), etc.). In embodiments, the network 102 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, network environment 100 is associated with a telecommunications provider that provides services to user devices, such as UE 108. For example, the network may provide voice and data services to user devices or corresponding users that are registered or subscribed to utilize the services provided by a telecommunications provider.

In network environment 100, a base station 106 facilitates wireless communication between the UE 108 and the network 102. Base station 106 serves as a communication point that forwards data from the UE 108 into the network 102 for further processing. In embodiments, the UE 108 may operate within a 5G network, transmitting user data that includes application traffic such as streaming, gaming, or messaging. In addition to user data, the UE 108 may also transmit metadata to the network 102. In aspects, the metadata transmitted from the UE 108 includes traffic-related metadata, such as application identifiers, packet size, protocol type, source and destination information, data volume, and timestamps. The UE 108 may also communicate traffic priorities and QoS requirements for different applications to the network 102. For example, low-latency gaming traffic may be prioritized over bulk file transfers.

The network 102 comprises multiple components, including a network storage component 104, the UPF 110, a data processing and analysis module 112, a reporting module 114, and a resource allocation module 116. In aspects, the UPF 110 manages the transmission and processing of user data between the base station 106 and the network 102. For example, the UPF 110 performs DPI to analyze packet headers and payloads, generating EDRs enriched with the traffic-related metadata that comprises organized key traffic details, such as application identifiers and/or service provider information. In aspects, DPI allows the UPF 110 to classify user traffic into specific applications (e.g., e.g., Netflix™, Xbox®, or messaging services), even in cases where traffic patterns may be encrypted. These EDR logs are then stored in a network storage component 104 for further processing.

The network storage component 104 serves as a centralized repository for aggregating EDR logs, wherein aggregating comprises sorting the EDR logs based on application identifiers associated with an application and/or a service provider information. This aggregation step prepares the data for advanced processing, such as clustering and anomaly detection. In aspects, the network storage component 104 may act as a buffer, preventing the data processing and analysis module 112 from being overwhelmed by real-time traffic. Additionally, by retaining EDR logs over time, the system enables retrospective traffic analysis and supports machine learning models, such as the Local Outlier Factor (LOF) algorithm, to identify outliers in the traffic-related metadata.

In various aspects, the aggregated and sorted EDR logs are then forwarded to the data processing and analysis module 112 where the data is further analyzed. In some configurations, such as real-time analysis or data storage is unnecessary, the data may bypass the network storage component 104 and flow directly to the data processing and analysis module 112. The data processing and analysis module 112 processes the EDR logs through clustering algorithms and/or anomaly detection algorithms to identify traffic patterns and traffic anomalies, such as outliers. In aspects, these outliers may be given an outlier score. As used herein, an outlier refers to a data point or a set of data points within the traffic-related metadata that deviates from the typical or expected behavior of telecommunications traffic patterns. The typical or expected behavior of traffic-volume patterns creates a threshold, and when an application has traffic volume that exceeds a threshold, it is considered an outlier. These deviations may indicate unusual activity, such as a sudden spike in traffic volume, irregular usage patterns, unexpected resource demands, and the like. Outliers may be characterized by an outlier score, which quantifies how much the data point deviates from its cluster density or expected range. For example, a traffic volume associated with a streaming service (e.g., Netflix™) that exceeds a predetermined threshold based on its historical patterns may be flagged as an outlier. Similarly, a sudden reduction in traffic volume for a typically high-demand application could also constitute an outlier, indicating a potential issue such as packet loss or degraded service. By correlating the outlier to specific traffic patterns, the system can also pinpoint the origin of the fluctuation, identifying whether it stems from a single high-demand application (e.g., Netflix™) or a broader event (e.g., live sports).

In embodiments, to analyze local density differences within the EDR log, the data processing and analysis module 112 employs machine learning (ML) algorithms, such as the Local Outlier Factor (LOF) algorithm, K-Means, or DBSCAN. The ML algorithms are configured to cluster data points and detect outliers. Clustering results may include an outlier score, with traffic patterns exceeding a predetermined threshold flagged as anomalies, and therefore identified as an outlier. In aspects, the algorithm (e.g., LOF) may calculate the density of data points within clusters to identify deviations that represent traffic spikes or anomalies. For example, if a sudden traffic surge occurs during a live sporting event or due to a new game release, the data processing and analysis module 112 may identify the specific application responsible for the increase.

Once an outlier has been identified by the data processing and analysis module 112, the reporting module 114 compiles the processed data into comprehensive reports that summarize each detected anomaly. In aspects, the outlier data is analyzed in relation to resource allocation at a radio access network (RAN) medium access control (MAC) layer to determine application-level network configuration adjustments. By analyzing the specific outlier(s) in relation to the RAN MAC layer, the system can assess how the traffic fluctuation interacts with lower-layer resource allocation mechanisms. This enables fine-tuned adjustments at the MAC layer, such as optimizing scheduling, prioritizing latency-sensitive traffic, or adjusting resource block assignments. This analysis also provides deeper insights into the impact of the traffic fluctuation, including how the outlier affects overall network performance, Quality of Service (QoS), and resource availability for other applications. For example, a sudden spike in traffic from a streaming application may cause congestion, resulting in degraded performance for other critical services like voice calls or gaming.

In aspects, the reporting module 114 is configured to compile the outputs of the data processing and analysis module 112 into comprehensive reports. These reports may include details such as the applications responsible for traffic anomalies, the timing and duration of traffic spikes, and associated data volumes. The reports may further identify application-level network configuration adjustments to address identified anomalies. In aspects, the reporting module 114 enables RF engineers to analyze traffic trends and correlate them with specific events or applications. These reports may also correlate the identified outlier to broader traffic patterns or external events. For example, the reporting module 114 may determine that a significant traffic spike was caused by a live-streamed NFL® game, pinpointing the specific event driving the anomaly. Similarly, the reporting module 114 may distinguish whether the outlier is isolated to a single application, such as Netflix™, or part of a larger trend affecting multiple applications in the network slice.

Once generated, the reports may be used to inform both retrospective network analysis, real-time decision-making, and proactive decision-making. In a retrospective context, the reports help operators understand the root causes of historical traffic fluctuations and implement preventative measures for future events. For real-time applications, the insights from the reports are forwarded to the resource allocation module 116, enabling dynamic network adjustments to mitigate the impact of the detected outliers.

In additional aspects, the reporting module 114 may play a role in capacity planning and configuration management by providing operators with predictive insights. For example, if a pattern of increasing traffic volumes is observed for a specific application, the system may recommend preemptive resource allocation or network configuration changes to prevent congestion during expected high-demand periods.

Next, the resource allocation module 116 utilizes the reports from the reporting module 114 to implement adjustments and dynamically allocate application-level network resources. Based on the identified traffic patterns and the identified outliers, the resource allocation module 116 is capable of adjusting network configurations and updating resource allocations to optimize performance and ensure QoS. In aspects, the data processing and analysis module 112 may identify that a traffic volume associated with a first application exceeds a predetermined threshold, marking it as an outlier. Based on the outlier status of the first application, the resource allocation module 116 may then allocate additional resources to the first application. For example, the resource allocation module 116 may prioritize bandwidth for streaming traffic during an NFL® game or preemptively scale capacity in anticipation of a major gaming event.

In various embodiments, the adjustments may include increasing bandwidth allocation for an application flagged as an outlier; prioritizing latency-sensitive traffic such as gaming or video conferencing; reallocating resources from low-priority applications to high-priority applications; proactively reserving resources for anticipated spikes in traffic based on patterns identified in prior reports; and the like.

In aspects, the system 100 can dynamically allocate network resources in the network 102 based on application-specific traffic patterns. The system 100 may identify a traffic volume associated with a first application and a second application, wherein the first application is characterized as an outlier based on exceeding a predetermined traffic threshold, and wherein the second application is not characterized as an outlier because it does not exceed the predetermined traffic threshold. Based on the first application's identified traffic volume, the system 100 may allocate additional resources to the first application. In additional aspects, the system may maintain current network allocations for the second application whose traffic volumes remain within the predetermined threshold.

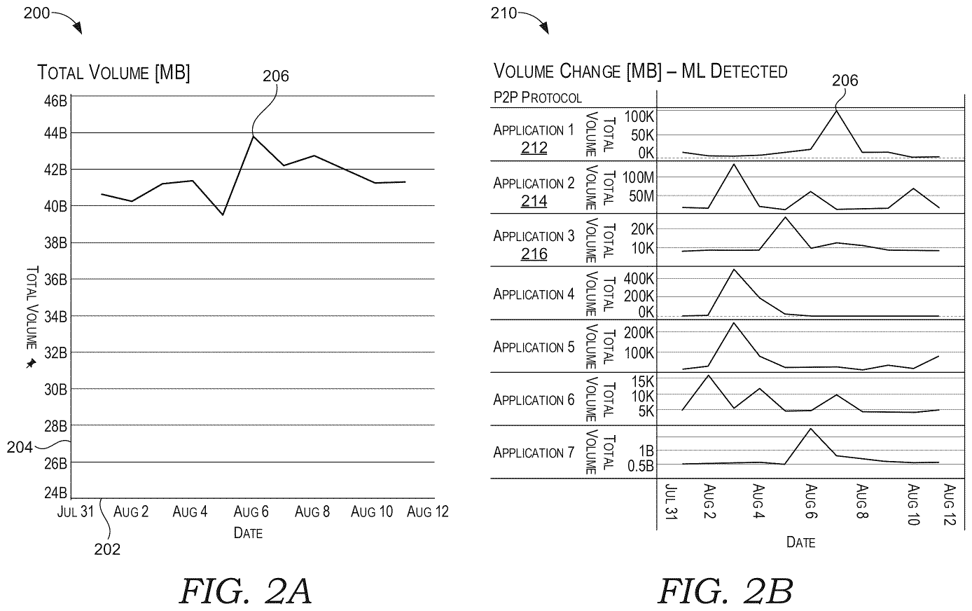

Turning now to FIG. 2, the system is illustrated through two complementary views of data processing. FIG. 2A illustrates an example of aggregated telecommunications data 200, representing total traffic volume over time in a telecommunications network. The view in FIG. 2A is the view RF engineers are able to see currently. The aggregated data 200 in FIG. 2A does not show application-specific information. Instead, all of the applications are lumped together into the total traffic volume. FIG. 2B illustrates an example of the breakdown of FIG. 2A's aggregated data into application-specific traffic patterns 210 using methods disclosed herein.

In FIG. 2A, the x-axis 202 represents time, while the y-axis 204 indicates the total traffic volume in megabytes (MB). In FIG. 2A, the x-axis 202 illustrates an example spanning from July 51 to August 12. As shown, the aggregated data 200 experiences a significant spike 206 on August 6, suggesting a sudden increase in network traffic. In aspects, this spike 206 could be attributed to a variety of sources, such as a popular event or application-related activity. At this stage, the system processes the EDRs generated by the UPF to retrieve traffic-related metadata associated with this spike, as discussed above in FIG. 1.

The metadata is then aggregated and sorted by the data processing and analysis module, grouping the EDR logs based on application identifiers or service provider information. FIG. 2B illustrates the second phase of the process, where the aggregated data 210 is categorized by specific applications, such as “Application 1” 212 (e.g., Netflix™), “Application 2” 214 (e.g., Xbox®), “Application 3” 216 (e.g., NFL® streaming), and so on, to identify the contributions of each application to the total traffic volume. In aspects, the data processing and analysis module may then employ clustering algorithms, such as LOF to detect anomalies and determine application-specific traffic outliers. The graph illustrated in FIG. 2B assists the RF engineers in determining which specific application caused the spike 206. For example, as shown, the traffic for Application 1 212 spiked significantly on August 6, aligning with the overall spike in FIG. 2A.

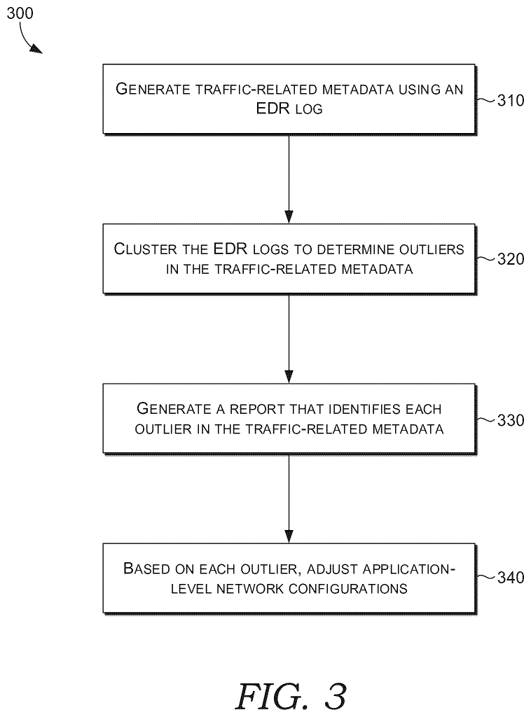

Turning to FIG. 3, a flow diagram is provided of a method 300 for identifying application-specific traffic patterns at a telecommunications network, in accordance with aspects herein. At block 310, traffic-related metadata is generated using an EDR log. The EDR log comprises application-specific traffic information, including metadata such as application identifiers, packet size, protocol type, source and destination information, and timestamps. At block 320, the EDR logs are processed through clustering algorithms to determine outliers in the traffic-related metadata. Machine learning techniques, such as the LOF algorithm, may be employed to group data points and calculate outlier scores based on density or deviation within the clusters. Traffic patterns that exceed a predetermined threshold are flagged as outliers, representing anomalies or irregularities in the network.

Following outlier detection, block 330 comprises generating a report that identifies each outlier and its associated metadata. This report includes details such as the specific application responsible for the anomaly, the timing and duration of the traffic fluctuation, and its impact on network performance. At block 340, the system adjusts application-level network configurations based on the identified outliers. This may include allocating additional resources to applications with anomalous traffic patterns, prioritizing latency-sensitive traffic, or updating resource allocation policies to optimize QoS.

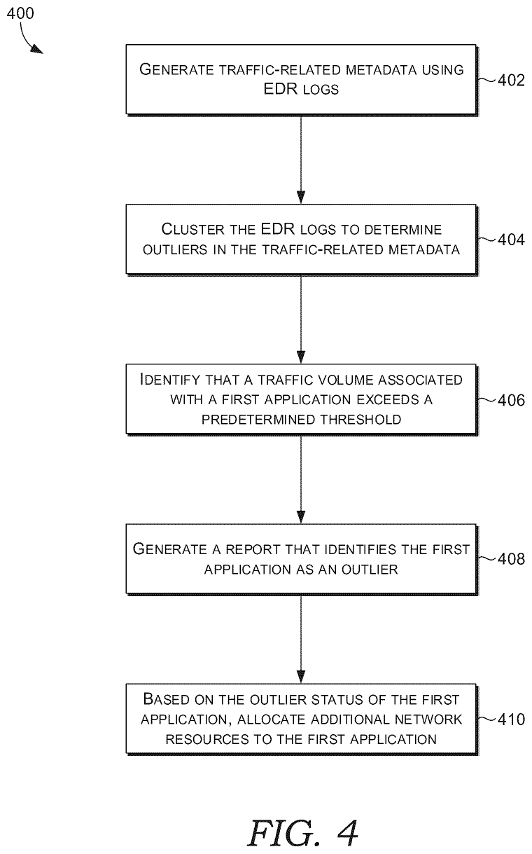

Turning to FIG. 4, a flow diagram of a method 400 for dynamically allocating network resources at a telecommunications network, in accordance with aspects herein, is illustrated. In block 410, traffic-related metadata is generated using EDR logs. In block 420, the EDR logs are processed through clustering algorithms to identify outliers in the traffic-related metadata. These outliers represent anomalies or irregular traffic patterns, such as sudden spikes in application usage, which may indicate potential congestion or unusual network activity. Following clustering, block 430 comprises analyzing the metadata to identify whether the traffic volume associated with a first application exceeds a predetermined threshold, characterizing it as an outlier.

Once the outlier is identified, block 440 generates a report detailing the anomaly, including the specific application responsible, the timing and magnitude of the traffic spike, and the impact on network performance. In block 450, the system dynamically allocates additional network resources to the first application based on its outlier status. These adjustments may include increasing bandwidth, prioritizing latency-sensitive traffic, or reallocating resources from lower-priority applications.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 502 that directly or indirectly couples various components together, including memory 504, processor(s) 506, presentation component(s) 508 (if applicable), radio(s) 520, input/output (I/O) port(s) 510, input/output (I/O) component(s) 512, and power supply(s) 514. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 512. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 504 may take the form of memory components described herein. Thus, further elaboration will not be provided here, but it should be noted that memory 504 may include any type of tangible medium that is capable of storing information, such as a database. A database may be any collection of records, data, and/or information. In one embodiment, memory 504 may include a set of embodied computer-executable instructions that, when executed, facilitate various functions or elements disclosed herein. These embodied instructions will variously be referred to as “instructions” or an “application” for short.

Processor 506 may actually be multiple processors that receive instructions and process them accordingly. Presentation component 508 may include a display, a speaker, and/or other components that may present information (e.g., a display, a screen, a lamp (LED), a graphical user interface (GUI), and/or even lighted keyboards) through visual, auditory, and/or other tactile cues.

Radio 520 represents a radio that facilitates communication with a wireless telecommunications network. Illustrative wireless telecommunications technologies include CDMA, GPRS, TDMA, GSM, and the like. Radio 520 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 520 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 510 may take a variety of forms. Exemplary I/O ports may include a USB jack, a stereo jack, an infrared port, a firewire port, other proprietary communications ports, and the like. Input/output (I/O) components 512 may comprise keyboards, microphones, speakers, touchscreens, and/or any other item usable to directly or indirectly input data into the computing device 500.

Power supply 514 may include batteries, fuel cells, and/or any other component that may act as a power source to supply power to the computing device 500 or to other network components, including through one or more electrical connections or couplings. Power supply 514 may be configured to selectively supply power to different components independently and/or concurrently.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for identifying application-specific traffic patterns in a telecommunications network, the method comprising:
generating traffic-related metadata using an event data record (EDR) log, wherein the EDR log comprises application-specific traffic information;
clustering the EDR logs to determine outliers in the traffic-related metadata;
generating a report that identifies each outlier in the traffic-related metadata; and
based on each outlier, adjusting application-level network configurations.

2. The method of claim 1, wherein the traffic-related metadata comprises one or more of: an application identifier, source and destination information, and data volume.

3. The method of claim 1, further comprising aggregating the EDR logs, wherein aggregating comprises sorting the EDR logs based on an application identifier associated with an application or a service provider.

4. The method of claim 1, wherein clustering the EDR logs comprises passing the EDR logs through an anomaly detection algorithm to calculate an outlier score.

5. The method of claim 4, wherein the anomaly detection algorithm is a local outlier factor (LOF) algorithm configured to analyze local density differences within the EDR log.

6. The method of claim 4, wherein application-specific traffic information with an outlier score higher than a predetermined threshold is identified as an outlier.

7. The method of claim 6, wherein the outlier is analyzed in relation to resource allocation at a radio access network (RAN) medium access control (MAC) layer to determine application-level network configuration adjustments.

8. The method of claim 7, wherein the application-level network configuration adjustment comprises updating resource allocation policies based on the outlier.

9. A system for identifying application-specific traffic patterns in a telecommunications network, the system comprising:
one or more processors; and
one or more computer-readable media storing computer-usable instructions that, when executed by the one or more processors, cause the one or more processors to:
generating traffic-related metadata using an event data record (EDR) log, wherein the EDR log comprises application-specific traffic information;
cluster the EDR logs to determine outliers in the traffic-related metadata;
generate a report that identifies each outlier in the traffic-related metadata; and
based on each outlier, adjust application-level network configurations.

10. The system of claim 9, wherein the processor performs deep packet inspection (DPI) at a user plane function (UPF) to retrieve the application-specific traffic information.

11. The system of claim 9, wherein determining the outlier in the traffic-related metadata further comprises:
identifying a traffic volume associated with a first application, wherein the first application is characterized as an outlier based on exceeding a predetermined traffic threshold;
identifying a traffic volume associated with a second application, wherein the second application does not exceed the predetermined traffic threshold; and
allocating additional network resources to the first application based on its identified traffic volume.

12. The system of claim 9, wherein the traffic-related metadata comprises one or more of: an application identifier, source and destination information, and data volume.

13. The system of claim 9, further comprising aggregating the EDR logs, wherein aggregating comprises sorting the EDR logs based on an application identifier associated with an application or a service provider.

14. The system of claim 9, wherein clustering the EDR logs comprises passing the EDR logs through an anomaly detection algorithm to calculate an outlier score.

15. The system of claim 14, wherein the anomaly detection algorithm is a local outlier factor (LOF) algorithm configured to analyze local density differences within the EDR log.

16. The system of claim 14, wherein application-specific traffic information with an outlier score higher than a predetermined threshold is identified as an outlier.

17. The system of claim 16, wherein the outlier is analyzed in relation to resource allocation at a radio access network (RAN) medium access control (MAC) layer to determine application-level network configuration adjustments.

18. The system of claim 17, wherein the application-level network configuration adjustment comprises updating resource allocation policies based on the outlier.

19. A method for dynamically allocating network resources in a telecommunications network based on application-specific traffic patterns, the method comprising:
generating traffic-related metadata using event data record (EDR) logs, wherein the EDR logs comprise application-specific traffic information for a plurality of applications;
clustering the EDR logs to determine outliers in the traffic-related metadata;
identifying that a traffic volume associated with a first application exceeds a predetermined threshold;
generating a report that identifies the first application as an outlier;
based on the outlier status of the first application, allocating additional network resources to the first application.

20. The method of claim 19, further comprising maintaining current network resource allocations for a second application whose traffic volumes remain within the predetermined threshold.
